(19) United States
(12) Patent Application Publication
(10) Pub. No.: US 2006/0176169 A1
(43) Pub. Date: Aug. 10, 2006

(54) System for sensing environmental conditions

(75) Inventors: David M. Doolin, El Cerrito, CA (US); Steve Glaser, Berkeley, CA (US); Nicholas Sitar, Orinda (CA); John Radke, Berkeley (CA)

Correspondence Address: Trellis Intellectual Property Law Group, PC, 1900 EMBARCADERO ROAD, SUITE 109, PALO ALTO, CA, 94303, US

(73) Assignee: The Regents of the University of California, Oakland, CA (US)

(21) Appl. No.: 11/303,458

(22) Filed: Dec. 16, 2005

Related U.S. Application Data
(60) Provisional application No. 60/637,279, filed on Dec. 17, 2004.

(51) Int. Cl. G08B 19/00; G08B 1/00; G08B 17/00; G08B 17/10

(52) U.S. Cl. 340/521; 340/628; 340/584; 340/531

(57) ABSTRACT

A system and method for facilitating measurement of environmental conditions such as might be used in emergencies or other situational awareness applications. The method includes dispersing several networked nodes in a region, the nodes being coupled to one or more sensors, and then employing the one or more sensors to sense one or more environmental conditions and providing sensed data in response thereto. In a more specific embodiment, the region exhibits a fire, and the method further includes utilizing the sensed data to predict fire conditions, such as fire movement and temperature. A controller may be employed to selectively adjust power to one or more sensors based on predetermined priorities associated with sensed data output from the one or more sensors.

### CLAIM OF PRIORITY

This invention claims priority from U.S. Provisional Patent Application Ser. No. 60/637,279, entitled WILDFIRE MONITORING SYSTEM USING WIRELESS NETWORK, filed on Dec. 17, 2004, which is hereby incorporated by reference as if set forth in full in this specification.

### ACKNOWLEDGMENT OF GOVERNMENT SUPPORT

This invention was made with Government support under Contract No. EAR-0121693 awarded by the National Science Foundation. The Government has certain rights to this invention.

### BACKGROUND OF THE INVENTION

This invention is related in general to wireless networks and more specifically to a wireless network used to sense environmental conditions for situational awareness and response, especially where positionally accurate data are necessary.

Systems for detecting and observing the environment can be used to provide a way to monitor, predict or control events such as fires, hazardous conditions, potential threats to people or property, etc. One type of event that can benefit from accurate monitoring is a wildfire such as a brush fire, forest fire, and building fire, etc. Other applications include threat evaluation and control, such as to guard against or responding to illicit acts by human perpetrators, hazardous conditions (e.g., chemical, gas, mechanical, natural, etc., and other events that are localized to an area. Such applications often demand versatile systems and methods to provide positionally accurate and timely data about the environmental conditions of an event, and the locations and environmental conditions associated with the personnel and equipment responding to the event.

In some cases it may not be possible to position sensing equipment ahead of an event because the location of the event is too unpredictable over a very large area. In such cases, it is usually important that any sensing system be rapidly deployable in addition to providing accurate, current data; and that the system be robust enough to handle changing conditions, such as damage to devices, loss of power, etc., that might occur in the face of an environmental condition or threat.

### SUMMARY OF EMBODIMENTS OF THE INVENTION

Embodiments of the invention provide a system and method for obtaining measurements of environmental conditions such as temperature, humidity, air pressure, position, elevation, ozone, CO₂, etc and the locations at which those data were collected. In general, any type of environmental condition can be measured and located. In one embodiment, the method includes creating a network of dispersed sensors. The network can be selectively controlled to configure and/or prioritize data that is sent to a processing system. The processing system can present the data in a user interface to human controllers for situational awareness applications. Data can also be provided to a simulation or model to predict behavior of an event or entity such as a wildfire, toxic spill, human mob, etc.

Sensors can be placed, dropped or targeted in an ordered arrangement or arbitrarily over locations or items in an area. In one embodiment, sensors are included upon “mobiles” such as people (e.g., firefighters, police, emergency workers, victims or injured parties, reporters, rescue or detection animals, etc.), vehicles, equipment or other targets. This allows individual and group tracking of the mobiles, or “assets,” that can be valuable to observer, respond to or control a situation or event.

One embodiment includes dispersing plural self-networking nodes in proximity to an event. Each self-networking node is in communication with one or more sensors and is able to transfer sensed data to other sensors for eventual relay to a destination, such as a processing system. The sensed data includes position information corresponding to one or more sensors of the sensor network. The position information is associated with sensed data corresponding to one or more measured environment conditions or measurements.

The sensed data may be selectively prioritized based on bandwidth, sensor communication capabilities, or other factors associated with the sensors. Power to each of the spatially dispersed sensors may be selectively adjusted according to one or more priority values associated with each of the spatially dispersed sensors.

### BRIEF DESCRIPTION OF THE DRAWINGS

FIG. 1 is a diagram illustrating a wireless sensor network for monitoring environmental conditions associated with a fire according to a first embodiment of the present invention.

FIG. 2 is a more detailed diagram of a node of the wireless sensor network of FIG. 1.

FIG. 3 is a diagram illustrating use of the wireless sensor network of FIG. 1 to sense the location of each sensor and the environmental conditions at the sensor location for situational awareness and response.

FIG. 4 is a flow diagram of a first method adapted for use with the wireless sensor network of FIG. 1.

### DESCRIPTION OF EMBODIMENTS OF THE INVENTION

For clarity, various well-known components, such as server operating systems, communications ports, Internet Service Providers (ISPs), and so on have been omitted from the figures. However, those skilled in the art with access to the present teachings will know which components to implement and how to implement them to meet the needs of a given application.

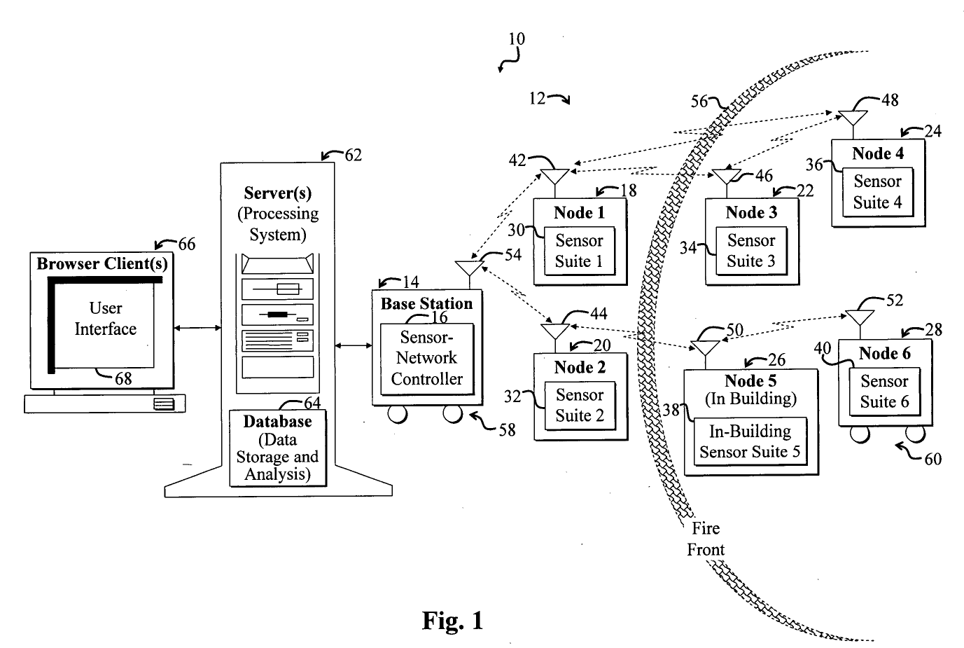

FIG. 1 is a diagram illustrating a wireless sensor network 10 according to a first embodiment of the present invention. In the present specific embodiment, the wireless sensor network 10 includes plural self-networking, self-locating environmental sensor nodes 12 in communication with a base station 14 running a sensor-network controller 16 for facilitating controlling the sensor nodes 12.

For illustrative purposes, the sensor nodes 12 are shown including a first sensor node 18, a second sensor node 20, a third sensor node 22, a fourth sensor node 24, a fifth sensor node 26, and a sixth mobile sensor node 28. The sensor nodes 18-28 are shown including sensor suites 30-40, respectively, for selectively wirelessly communicating sensed data to the base station 14 via respective sensor antennas 42-52 and a base station antenna 54. A fire front 56 is shown approaching the first sensor node 18 and the second sensor node 20 after having passed the third sensor node 22, the fourth sensor node 24, the fifth sensor node 26, and the sixth sensor node 28.

In the present specific embodiment, the base station 14 is a mobile base station, exhibiting base station wheels 58. Similarly, the sixth mobile node 28 exhibits node wheels 60. While only two network nodes 14, 28 are equipped with wheels, more or fewer nodes of the network 10 may be made mobile without departing from the scope of the present invention. Furthermore, the mobility mechanisms other than wheels may be employed without departing from the scope of the present invention. In addition, the antennas 42-54 may represent Radio Frequency (RF) transceivers, laser transceivers, or other types of wireless communications mechanisms.

The base station 14 further communicates with one or more servers 62 running a database 64 for maintaining sensor data, also called sensed data. The sensed data is output by the sensor suites 32-52. Examples of sensed data include temperature data, humidity data, blackbody radiation data, and Global Positioning System (GPS) position data. The position data may include elevation data. Sensed data may further include various conditions pertaining to a fire, such as fire movement or temperature. Fire movement and velocity may be calculated by software, such as the database 64, by analyzing reported temperature data from the various sensor nodes 12 at specific times.

The database 64 may maintain other types of data other than just sensor data without departing from the scope of the present invention. For example, the database 64 may be employed to facilitate implementing an algorithm for predicting movement, temperature, and other characteristics of the fire front 56 based on the sensed data. Data pertaining to the predicted fire movement and behavior may be stored in the database 64 along with sensed data.

Sensed data maintained by the database 64, which may be implemented via a My SQL® or another type of database, is accessible via one or more browser clients 66 in communication with the one or more servers 62. The browser client 66 includes a user interface 68 for facilitating user access to the sensed data.

In operation, the self-networking sensor nodes 12 are pre-dispersed in fire-prone regions. Alternatively, the sensor nodes 12 may be dispersed in or in proximity to the fire 56 in real time as the fire front 56 progresses. Pre-dispersed sensor nodes may be augmented with newly dispersed sensor nodes as needed to meet the needs of a given situation. Additionally dispersed sensor nodes are adapted to automatically self-network with pre-dispersed nodes upon dispersal. The sensor nodes 12 may be dropped by air, foot, vehicle, or by other mechanisms. The sensor nodes 12 may be implemented via miniature disposable devices. Additional mechanisms, such as special stands and/or parachutes (not shown), may be employed to ensure that the sensor suites 12 deploy in optimum positions relative to the terrain.

The base station 14 may be dispersed similarly to the sensor nodes 12 without departing from the scope of the present invention. Furthermore, while only one base station 14 is shown, plural base stations may be employed.

For the purposes of the present discussion, a self-networking node may be any device that begins communicating with surrounding devices upon dispersal to facilitate implementing a network. A self-networking node may automatically begin communicating with proximate nodes upon dispersal or may be triggered to begin networking in response to certain events, such as in response to a remote control signal. The use of self-networking nodes may facilitate rapid sensor-network deployment, organization, and operation.

Upon dispersal, the self-networking nodes 12 employ a self-networking protocol to detect signals from neighboring nodes and to establish communications therewith. For example, the fourth node 24 may detect a strong signal from the third node 22 and visa versa, and then automatically establish a wireless connection with the third node 22. The third node 22 may detect signals from the first node 18 and visa versa, and then automatically establish communications with the first node 18 in addition to the fourth node 24. Similarly, the first node 18 may detect signals from the base station 14 and visa versa, and then subsequently establish communications between the base station 14 and the first node 18. Upon establishing communications between the base station 14, the first node 18, the third node 22, and the fourth node 24, data sensed by the various nodes 18, 22, 24 may be relayed to the base station 14. For example, sensed data from the fourth sensor node 24 may be relayed to the base station 14 via the first node 18 and the third node 22. However, if the fourth node 24 successfully establishes suitable communications with the first node 18, the fourth node 24 may choose to relay data to the base station 14 via the first node 18 instead of via the third node 22 and the first node 18.

The communications-link bypassing of the third node 22 by the fourth node 24 to communicate with the first node 18 is called sensor-position hopping. Position information in addition to signal-strength information associated with each node 18-28 may be employed to facilitate communications decisions made by each of the nodes 18-28. Hence, hopping may be based on sensor position, signal strength, or other parameters.

Relay nodes can be used. A relay node is used to re-broadcast a received signal to one or more other nodes in order to extend the range, or provide needed continuity, in the wireless network. Any number of nodes can send to a relay node. The relay ability can be used in a node with or without sensing ability. Nodes can also be provided with the ability to aggregate and store results from other nodes. In one embodiment, sensor nodes report to one or more relays located remotely from the base station. Each relay may store and aggregate sensor data to forward to a base station using long range communication such as radio or cell phone. Nodes such as relays may also have the capability to perform processing of sensed data for analysis and automated control of the sensors in the network. Relays may be placed dynamically as the network is deployed, may be pre-positioned in advance of the network, or deployed in some other manner congruent with establishing communication with one or more base stations so that the sensor data may ultimately be processed and examined.

Various mechanisms for implementing self-networking nodes are known in the art and may be employed for the purposes of implementing embodiments of the present invention without departing from the scope thereof.

After the following has occurred: the sensor nodes 12 are dispersed; the base station 14 begins communicating with one or more of the sensor nodes 12; and the server 62 has established communications with the base station 14, then data collection begins. In practice, when the server 62 begins communicating with the base station 14, the browser client 66 will have access to the server 62. For the purposes of the present discussion, the server 62 and accompanying browser client 66 represent a processing system for receiving data from the sensor suites 30-40 via the base station 14 based on priority values associated with each sensor suite 30-40 and/or priority values associated with each individual sensor of the sensor suites 30-40.

As the fire front 56 progresses, various measurements are made by the sensors of the sensor suites 30-40 as discussed more fully below. Such measurements may include measurements of temperature, humidity, radiation, and so on, which represent environmental conditions.

Various aspects of the embodiment 10 of FIG. 1 are application-specific. Examples of such aspects include numbers and types of sensors employed in each sensor suite 30-40; the positions of the sensor suites 30-40, such as positions relative to the flame front 56 and positions relative to themselves; the time at which the sensor suites 30-40 are dispersed relative to the start of the fire 56, and so on.

The sensors of the sensor suites 30-40 may periodically take measurements and forward the resulting measurements, i.e., sensed data, to the base station 14 via one or more intervening nodes. Alternatively, the sensors of the sensor suites 30-40 take measurements and forward the results to the base station 14 in response to queries from the sensor-network controller 16 running on the base station 14. Alternatively, the sensor nodes 12 may be configured so that sensors of the sensor suites 30-40 continuously provide measurements to the base station controller 14.

The exact configuration of the sensor suites 20-30 and accompanying nodes 18-28 specifying how sensed-data is handled is application-specific and may be different for different applications. In the present specific embodiment, the sensed-data-reporting behavior of the nodes 12 is configurable via the user interface 68 of the browser client 66, which may be employed to access and configure the sensor-network controller 16. The sensor-network controller 16 running on the base station 14 implements one or more routines that enable users to selectively prioritize which types of data are being reported from the sensors of the sensor suites 30-40 and how the selected types of data are reported, such as continuously, periodically, and/or selectively. Software and modules required to implement various aspects of the present embodiment may be readily constructed or purchased.

In an exemplary operative scenario, as the flame front 56 advances past the nodes 22-28, sensed-data reported by the nodes 22-28 reflects an increase in temperature as the flame front advances; a peak temperature when the flame front arrives at each node 22-28; and a settling temperature that is higher than the initial temperature before the approach of the flame front 56. Similarly, the sensor suites 34-40 of the nodes 22-28, respectively, may detect variations in humidity, radiation levels, and so on.

The sensor-network controller 16 runs one or more routines that associate the sensed data output from each sensor suite 30-40 with the corresponding position of the sensor suite 30-40 as reported by GPS receivers accompanying the sensor suites 30-40. GPS receivers are considered sensors for the purposes of the present discussion. Furthermore, position data, including sensor-elevation information associated with each sensor suite 20-40 is considered to be a type of sensed data.

Alternatively, one or more routines running on the sensor nodes 12 combine sensor position information with sensed data output from sensors that are associated with the position information. The combined data is then periodically forwarded to the sensor-network controller 16 of the base station controller 14. When sensed data, such as temperature data, is combined or associated with position information, the temperature data is said to be geocoded, and the combination of the temperature data and position data represents geocoded data. For the purposes of the present discussion, the term geocode may be the act of coupling position or location information with other types of data.

One or more fire-analysis programs, which may be implemented by the database 64, employ the sensed data in combination with positions associated with the sensed data to perform fire analysis. The fire analysis may include predicting where the flame front 56 will move and whether the flame front will be hot enough to burn certain structures, such as a building (not shown) housing the fifth node 26. Furthermore, sensor data output from the sensors of the in-building sensor suite 38 may be coupled with sensed data output from surrounding nodes, such as the sixth node 28, to facilitate determining modes of building failure. For example, sensors of the sensor suite 38 may be positioned along certain beams to enable temperature measurements, which might indicate that the temperature was hot enough to melt certain beams.

The system 10 for facilitating for measuring environmental conditions provides various significant advantages over conventional fire monitoring systems. Advantages include the ability to implement rapidly deployable inexpensive networks; the ability to implement disposable self-networking networks; the ability to obtain accurate position and elevation information correlated with environmental measurements to facilitate fire analysis; the ability to selectively prioritize the reporting of sensed data to optimize network usefulness for performing desired fire analysis; and so on. The ability to rapidly deploy sensors in difficult and adverse environmental conditions, and the capability of having such rapidly deployable sensors self-organize into networks and then automatically interact with pre-existing support infrastructure may facilitate providing critical information for property and life-safety management during wildfire evolution.

Conventional systems are often adapted to observe the flame front 56 from a distance from a single point, and consequently are limited in their ability to facilitate fire analysis. Unlike with embodiments of the present invention, various measurements of environmental conditions taken as the flame front passes 56, such as soil moisture, wind, humidity, and terrain distribution, cannot generally be accurately determined via conventional fire-observation and measurement systems, which generally observe fires from afar and do not employ nodes that can withstand the heat of a fire or that are otherwise disposable. For the purposes of the present discussion, environmental conditions may be characterized by any parameters, values, or other data that may be sensed by a sensor. Additional examples of environmental conditions include ultraviolet light flux, sound, and microwave energy.

In one embodiment, sensor nodes 12 are deployed in an area of interest, such as an area that might be susceptible to a fire, or in the path of the advancing wildfire 56. The sensor nodes 12 may be deployed via air or by attaching the sensors to a person, ground vehicle, structure, etc. In some cases, it may be necessary or convenient to pre-install sensors, sensor networks and supporting network infrastructure such as base stations for satellite or cell communication. Deployment can be systematic, such as by regular, patterned placement by humans or machines; or arbitrary such as by thrown or dropped batches of sensors by land or air. Other types of deployment are possible.

The base station 14 and accompanying sensor-network controller 16 can be configured, via the browser client 16, to perform different function, such as aggregating and correlating data, filtering data, monitoring nodes, etc. In the present specific embodiment, a primary function of the base station 14 is to act as a central radio-frequency receiver/transmitter and relay to server 62 which, in turn, provides data from the nodes 12 to the client 66. The client 66 can operate automatically or in interaction with human operators to analyze data, monitor and report on conditions, make predictions and issue commands to the nodes 12 via the server 62 and base station 14. Note that in practice several or many base stations 14 can be used, each with an associated plurality of node 12. Base station coverage can overlap to provide robustness via redundancy. Such overlapping coverage can also improve overall bandwidth of communications from and to nodes.

Sensors 30-40 on the sensor nodes 18-28 can be prioritized so that if there is a lack of resources (e.g., limited bandwidth), the sensor readings with higher priority can be communicated first. Data of sensor types with lower priority can be buffered and transmitted when there is free bandwidth at a later time, or discarded and not sent at all. If a node starts to become low on power, sensors with higher priority can remain active while lower priority sensors are shut down.

Note that the specific number and arrangement of devices, such as the sensor nodes 12 of FIG. 1, is only for purposes of illustration. In general, features of embodiments of the invention can work with any suitable types of network devices and network topology, protocol, communication links, etc. For example, communications among the sensor nodes 12 and the base station 14 can be by radio frequency, infrared, laser, hardwired or other arrangement. Protocols such as session initiation protocol (SIP), Internet protocol (IP), hypertext transfer protocol (HTTP), etc., can be used. Processing performed by server 62 and client 66 can be by any suitable one or more processors that can work in real-time or non-real-time (e.g., batch, offline, etc.) modes; parallel or distributed processing, etc.

One embodiment (not shown) of the invention uses fire equipment such as fire engines to provide base station support for nodes deployed in the terrain, on the fire fighters, and on fire fighting vehicle. The nodes may be used to collect environmental data at each fire fighter's location, and report data collect from sensors measuring physical condition of fire fighters, such as body temp, etc. Base stations can also be made mobile as where base station functionality is carried in a vehicle, remotely operated vehicle (i.e., “drone”), physically carried by personnel, etc.

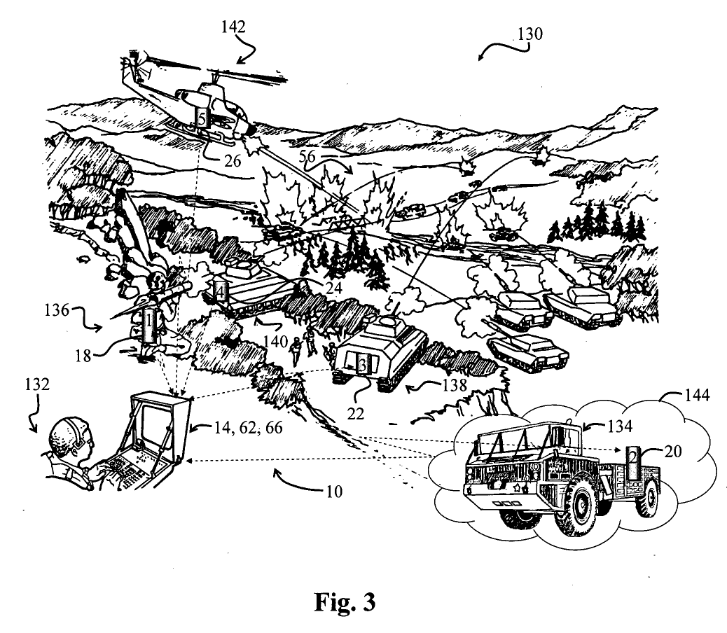

Another embodiment of the invention uses a mobile base station attached to a fire fighter or soldier as discussed more fully below with reference to FIG. 3. The firefighter, soldier, or other personnel may employ the base station to communicate via long distance radio, satellite etc. as a relay to back end servers. Base stations can be pre-deployed to collect data from mobile nodes mounted on fire fighters or other personnel, which interact with previously or concurrently deployed stationary nodes.

Personal sensor nodes can be useful in situations where environmental conditions are highly localized and can vary critically across small distances. For example, where hazardous materials or chemicals, especially in a gas state, are of concern to humans it is useful to monitor environmental conditions in the immediate vicinity of each human. Personal or animal sensor nodes can include the ability to interface with biometric sensors for pulse, respiratory, body temperature, etc. Or to detect other biometrics in creatures that come near someone wearing the personal sensor. Note that any features of personal sensors may equally be applied to static or vehicle-mounted sensors and vice versa.

One application includes personal ozone monitoring sensors (Or CO or CO2 or methane or any other volatile or poisonous gas). Ozone is an air pollutant and can be harmful to humans. It is used in various industrial applications as, for example, in wineries as a sanitization agent for barrels and other wine fermentation and storage vessels as a replacement for chlorinated cleaning agents.

An ozone monitoring sensor node can be a personal wireless monitoring device capable of determining the amount of ozone in the environments. The ozone sensor can compute hourly and daily average exposures to ozone. The sensor can transmit current instantaneous measurements of ozone, average measurements over time, or other values or computations to other receivers or a central processor. In a preferred embodiment, each sensor node includes an integrated visual and audio alarm system. An alarm is triggered when a threshold value of a predetermined level is exceeded. An alarm can include a light and/or audible alarm so that an individual within range of a dangerous concentration of ozone can hear the sound. exceeding a safe threshold can also result in transmission of electronic indications of an alarm to all wireless client devices and to a central processing station.

In a preferred embodiment, a node includes one or more separate sensors mounted on a printed circuit board with a control system. However, any other node design is possible including designs without printed circuit board mounting, microelectromechanical (MEMS) approaches, use of biological or quantum processors, etc. The sensors and control system can be operated by a microcomputer which may be located on the same or on a different device. Nodes may have capability for storing finite sample data on board the node itself. Node tracking of positions can be enabled by onboard GPS positioning, what relative to a fixed network of ambient environment monitoring nodes using technologies such as RFID. The sensor includes integrated wireless communication radios for sending electronic alarms, and allows the sensor to be integrated into an existing center network using standard or compatible data transmission protocols. Data collected and processed by the ozone sense or may be transmitted to clients on a predetermined time interval or by demand.

Another application includes infantry and equipment tracking in combative applications such as Military Operations in Urban Terrain (MOUT). Sensors including location detectors (locators) may be attached to personnel such as infantry, medical, or other people associated with operations in urban or rural environments. Data reported from these locators could also include local environmental conditions such as temperature, light conditions, humidity, and could also interface with biometric sensors to report pulse, body temperature, respiratory rate, etc.

Sensors can advantageously be attached to equipment such as a gun, mine, rescue flare, etc. to report on where the equipment is (location coordinates), whether the device has gone off or is being used, etc. Another approach includes loosely mounting sensors to equipment in a non-permanent mode so that the sensors can be deployed or dispersed incidentally while a person, animal, device or vehicle is moving such as by vibration due to shaking or jostling, scraping forces of rubbing against buildings or bushes, etc. Other effects such as wind, rain, moisture, etc. can also act to deploy the loosely mounted sensors or nodes.

The system could be effectively deployed during MOUT operations similarly to deployments during fire, flood or terrorist responses etc. With appropriate relay mounted on vehicles such as helicopters or reconnaissance drones, the locator and personal sensor system could be deployed for supporting remote operations in rural areas.

Other types of military, paramilitary, combative or law enforcement applications can include widely distributed police or anti-guerrilla activity can use an airborne base station such as in a plane, helicopter, drone, etc. Such applications can also use sensors attached to enemies, suspects, perpetrators, or “neutrals” such as bystanders, friendly or neutral troops, etc. Sensors can be applied unbeknownst to a person such as where stationary sensors on fences, vegetation, etc. latch onto a person trying to enter a restricted area, such as in a border crossing.

Latching sensors or nodes onto a person or animal can be by mechanical means such as where tiny barbs are used to catch clothing, hair or other body parts or physical artifacts. Other latching can include obvious but non-removable methods such as putting nodes into handcuffs, flexible bracelets, identification necklaces, ankle bracelets, etc. These approaches can be used for prisoners, prisoners of war, injured persons (who may inadvertently remove a node, for example), illegal immigrants, etc. Nodes can be fixed to a person so that they cannot be easily removed except by an authorized person. Nodes can be made robust enough to survive significant abuse such as by embedding the node in touch material or making the node difficult to access.

In some cases, recording the location and environmental conditions of personnel and equipment associated with an incidence or event is as important or more important than statically monitoring conditions in selected locations. In such cases, each entity to which sensors are attached must registered to the host identity and function, for example, a named person filling a certain role in the incidence response. The system handles registering these identities and providing data associated with each registered entity on a timely and situational-relevant basis.

Although embodiments of the invention may be presented herein primarily with respect to specific applications, many other suitable applications are possible.

Additional sensor-network details that may be employed to facilitate implementing embodiments of the present invention are described in various papers, including:

“Wireless Sensors for Wildfire Monitoring,” (8 pages) D. Doolin, N. Sitar, May 2005;

“Rapid Prototyping and Deployment Chassis for Wireless Sensor Devices,” (3 pages) D. Doolin, N. Sitar, May 17, 2004; and

“Design and Construction of a Wildfire Instrumentation System Using Networked Sensors,” (1 page) M. Chen, C. Majidi, D. Doolin, S. Glaser, N. Sitar, Jun. 17, 2003.

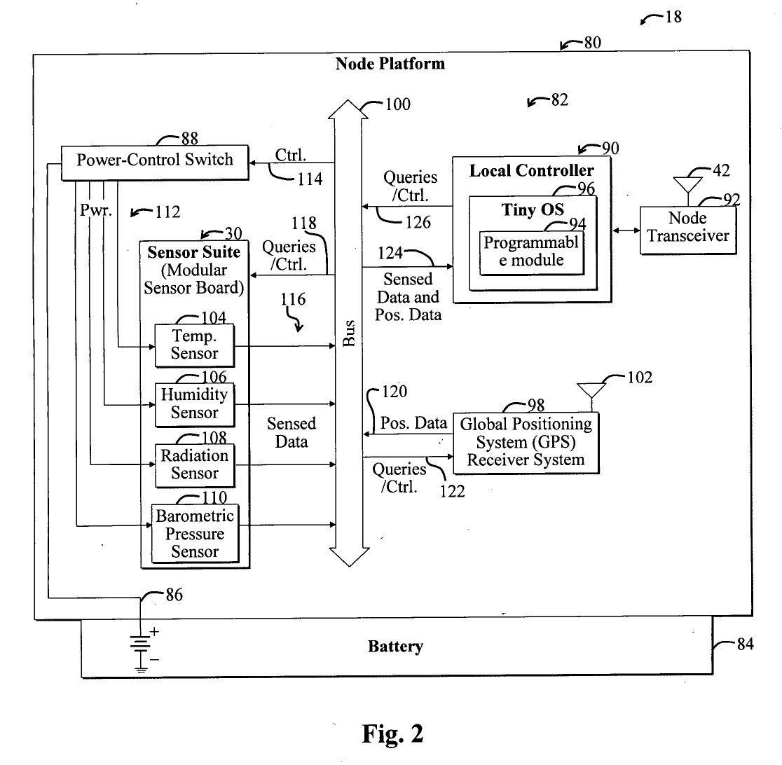

Hence, with reference to FIGS. 1 and 2, the sensor network 10 implements a network wherein a processing system 14, 62, 66 receives data from the sensors 104-110, one or more of which are assigned one or more priority values via the browser client 66. The server 62 and client 66 of the processing system 14, 62, 66 receive sensed data 124 from the base station 14 of the processing system 14, 62, 66, which was relayed to the base station 14 via one or more of the sensors 104-110. The processing system 14, 62, 66 receives the sensed data 124 according to the one or more priority values.

In the present specific embodiment, a process 94 executes at a device, such as the first sensor node 18, for preventing operation of a sensor, such as pressure sensor 110, depending on a criterion. The criterion may include a determination of a low-power condition or a restricted-bandwidth condition by the local controller 94, which would result in prohibitive degradations in the sensed data output by the sensor if transmitted. The local controller 90 implements one or more processes for organizing a flow of data, such as sensed data, from the sensor nodes 18-28 to the base station 14 after deployment of the sensor nodes 18-28.

The wheels 58, 60 in the base station 14, and sixth node 60 represent mechanisms for pre-deploying the sensor nodes 12 in an area and/or for deploying the sensor-nodes during a fire event. Other mechanisms, for selectively deploying sensors, such as aircraft, are not shown. The browser client 66 and server 62 of FIG. 1 implement a mechanism for facilitating modifying data-collection priorities according to a data type, a data collection rate, fire conditions, and/or values of data collected.

The sensor nodes 12, also called motes, may include various types of sensors. For example, position, temperature, moisture or humidity, air pressure, force, light, and other sensors can all be used. A single node can have multiple sensors and different nodes can use different numbers and types of sensors than other nodes. Depending on the type of application, different types of sensing may be more desirable than others, and sensor characteristics such as sensitivity, ruggedness, sample rate, power consumption, transmit/receive range, etc., may be more critical than others.

Nodes can have pre-programmed behavior so that the need for transmitting commands to a node is reduced. Another option is to allow each node to be programmable so that node behavior, such as sensor sampling rate, transmit range, communications relay ability, etc., can be adjusted from a control center. Node firmware and software can be downloaded to each node from a control center, such as the base station 14, server 62, and/or other device.

FIG. 2 is a more detailed diagram of a node 18 of the wireless sensor network 10 of FIG. 1. The exemplary sensor node 18 includes a node platform 80 upon which is mounted sensor-node electronics 82, which are powered via a battery 84. For clarity, various battery connections and traces are not shown in FIG. 2 with the exception of a power signal 86 to a power-control switch 88 mounted on the node platform 80.

In the present specific embodiment, the sensor-node electronics 82 include a local controller 90, which runs a programmable control module 94 via a TinyOS operating system 96. The local controller 90 communicates with a node transceiver 92 and accompanying antenna 42. The local controller 90 also communicates with the power-control switch 88, the sensor-suite 30, and a GPS receiver system 98 via a bus 100. The GPS receive system 98 includes an accompanying GPS receiver antenna 102.

For illustrative purposes, the sensor suite 30 is shown including a temperature sensor 104, a humidity sensor 106, a radiation sensor 108, and a barometric pressure sensor 110, which selectively receive power 112 from the power-control switch 88 based on power-control signals 114 received from the local controller 90. The sensor suite 30 is implemented via a modular sensor board that may be easily unplugged from the node platform 80 and replaced.

While the present specific embodiment employs the bus 100 to facilitate connections between various sensor-node modules 30, 88, 90, 98, other mechanisms and architectures may be employed without departing from the scope of the present invention. For example, the controller 90 may connect directly to the various modules 30, 88, 98. Furthermore, one or more of the modules 30, 88, 90, 98 may be omitted or implemented elsewhere without departing from the scope of the present invention.

In operation, with reference to FIGS. 1 and 2, the sensors 104-110 selectively take environmental measurements and forward resulting sensed data 116 to the local controller 90. The local controller 90 may include or communicate with additional memory, such as an Electrically Erasable Programmable ROM (EEPROM) (not shown), to perform various functions, such as to facilitate temporarily storing sensed data in preparation for transfer to the base station 14 of FIG. 1.

The sensor suite 30 receives control signals and queries 118 from the controller 90 via the bus 100. The control signals and queries 118 facilitate establishing sensor behavior, such as measurement frequency. Sensor behavior may be automatically controlled via one or more routines running on the local controller 90 and based on predetermined sensor priorities. Alternatively, sensor behavior is configured via control signals forwarded to the local controller 90 from the browser client 66, server 62, and sensor-network controller 16 of the base station 14 of FIG. 1.

The GPS receiver system 98 selectively provides position data 120, 124 such as latitude and longitude coordinates in addition to elevation information, to the local controller 90 in response to GPS queries and/or control signals 122, 126. The local controller 90 may run one or more routines for selectively powering-off or powering-on the GPS receiver system 98 via the control signals 122, 126. Alternatively, the GPS receiver system 98 is pre-configured to automatically power-off after an initial position data is determined and forwarded to the local controller 90, thereby saving energy. In the present specific embodiment, the local controller 90 may power-up and query the GPS receiver system 98 as needed, such as in response to a request from the from the browser client 62 of FIG. 1 as relayed to the sensor node 18 via the server 62 and base station 14.

The local controller 90 employs the node transceiver 92 to selectively transmit sensed data 116, 124 from the sensor suite 30 and GPS receiver system 98 and to receive data, such as control signals, from other nodes, such as the base-station node 14 and the third node 22 of FIG. 1. After the node 18 is dispersed in a fire region or a fire-prone region, such as by aerial drop, the node 18 automatically powers-on.

Subsequently, the GPS receiver system 98 forwards position information to the local controller 90 and powers off. The sensed data output from the sensors 104-110 of the sensor suite 30 is then combined, i.e., geocoded with the position data output from the GPS receiver system 98 via the local-controller 90 before the resulting geocoded data is forwarded to the server 62 via the base station 14 of FIG. 1. Alternatively, the position data 120 is associated with the sensor node 18, such as via a tag, and then forwarded to the server 62. Similarly, sensed data output from the sensor suite 30 may be tagged and forwarded to the server 62, which then geocodes the data to facilitate fire analysis and prediction operations.

Control signals received by the local controller 90 from the base station 14 of FIG. 1 may specify priority values to each of the sensors 104-110, thereby effectively prioritizing sensed data output from the sensors 104-110. In the present specific embodiment, power input to each of the sensors 104-110 is selectively modulated in response to control signals 114 received by the power-control switch 88 via the local controller 90. The control signals 114 may be automatically generated by one or more routines running on the local controller 90 in response to external control signals received by the local controller 90 from the base station 14. Alternatively, the local controller 90 automatically controls power levels to the sensors 104-110 based on pre-fixed priority values.

The local controller 90 may include an Input/Output (I/O) switch (not shown) that is responsive to control signals from a central controller, such as the central sensor-network controller 16 positioned to the base station 14 of FIG. 1. Controllable I/O switches may be used to facilitate data flow to and from the sensor nodes 12.

Those skilled in the art may employ various well-known modules to facilitate implementing the sensor node 18 without undue experimentation. For example, nodes made by Moteiv may be employed to implement embodiments of the present invention without departing from the scope thereof. An exemplary Moteiv node, called a sky mote, employs an IEEE 802.15.4-compliant Chipcon CC2420 wireless transceiver that can achieve data rates of upto 250 kbps and communicates at 2.4 GHz. The sky mote purportedly can provide a range of 50 meters indoors and 125 meters outdoors with an integrated onboard antenna. The sky mote further includes a Sensirion AG relative humidity sensor, a Sensirion temperature sensor, a Hamamatsu Photosynthetically active radiation (PAR) sensor, a Hamamatsu Total Solar Radiation (TSR) sensor, a TI MSP430-ontroller internal temperature sensor, a TI MSP430-controller internal voltage sensor, and an Intersema pressure sensor.

FIG. 3 is a diagram illustrating use of the wireless sensor network 10 of FIG. 1 to sense the location of each sensor and environmental conditions at or near a node for situational awareness and response in a battle scene 130. With reference to FIGS. 1 and 2, the base station 14, server 62, and browser client 66 are implemented via a single unit 14, 62, 66 carried by a first soldier 132, which may be a firefighter or other type of personnel without departing from the scope of the present invention. The first node 18 is shown carried by a second soldier 136 and used to monitor vital signs, such as blood pressure, in addition to external environmental conditions, such as carbon monoxide levels, biological weapons residues, and so on, in combination with the position of the soldier 136. For the purposes of the present discussion, vital signs represent a type of biological information. Biological information may be any information pertaining to a living system, such as blood pressure, pulse rate, body temperature, and so on. Such additional sensors for measuring biological information pertaining to a person may be readily implemented by replacing the modular sensor board 30 of FIG. 2 with a sensor board or flex circuit that includes additional biological sensors.

The second node 20 is shown mounted on a mobile truck 134. The third node is mounted on a first tank 138. The fourth node is shown mounted on a second tank 140. The fifth node 26 is shown mounted on a helicopter 142. Note that nodes implemented according to the teachings of the present embodiment may be placed on first responders, casualties, and other parties on scene, as well as equipment.

Hence, for the purposes of the present embodiments, sensing can be triggered or controlled or modified in reaction to events or other criteria. For example, where a concentration of a toxic or dangerous gas 144 such as carbon monoxide is being sensed, a node, such as the second node 20, can be programmed to report infrequently on concentrations below a predetermined level. If concentration exceeds a threshold (e.g., maximum safe exposure time is 2 hours or less) then the node 20 can send the sampling or an alert message at a high priority. The node 20 can begin sampling the carbon monoxide level more frequently and give the appropriate sensor a higher priority. When the condition becomes safe (i.e., does not exceed the threshold) the node 20 and sensing operation can go back to the previous state. One sensor reading can be used to modify the operation and reporting of other sensors. For example, if temperature increases then harmful gas monitoring can be increased in frequency, reporting, priority, etc.

Nodes and sensors can be applied to movable objects other than tanks 138, 140, trucks 134, helicopters 142, or soldiers 136, 132. For example nodes and sensors can be applied to movable objects such as robotic rovers, firefighters and other vehicles.

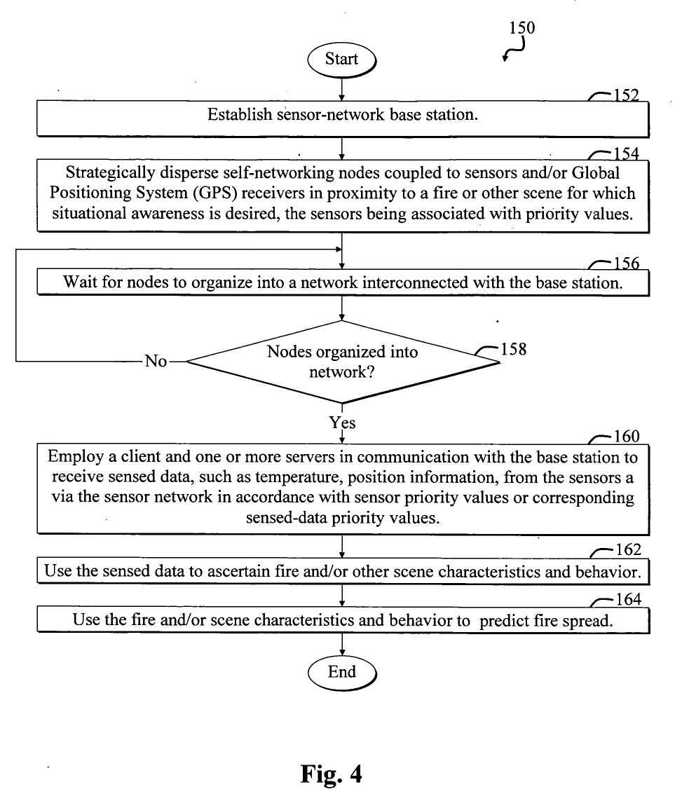

FIG. 4 is a flow diagram of a first method 150 adapted for use with the wireless sensor network 10 of FIG. 1. The method 150 includes an initial base-station establishing step 152, wherein a network base station, such as the base station 14 is established. A base station is established by positioning the base station in a desired region and powering-on the base station.

In a subsequent node-dispersing step 154, various self-networking nodes, such as the nodes 12 of FIG. 1, which are coupled to sensors and or GPS receivers, are dispersed in the desired region. Subsequently, communications between the nodes and the base station are established in a node-organizing step 156.

After the nodes of the network are sufficiently connected in a network, then an environment-observing step 160 is performed. The environment-observing step 160 includes employing a client, such as the browser client 66 of FIG. 1, to communicate with one or more servers in communication with the base station. The environment-observing step 160 further includes receiving sensed data, such as temperature and sensor position information, including elevation information, from the sensors via the network according to predetermined priority values associated with each sensor.

In a subsequent data-analysis step 162, one or more environment-analysis, such as fire-analysis routines, are employed to ascertain fire or other scene characteristics and behavior via the sensed data. Subsequently, one or more prediction routines are employed to predict the future fire characteristics and behavior, such as movement. The routines to implement sensed-data analysis and fire prediction may be implemented via software, such as the database software 64 running on the server 62 of FIG. 1.

An alternative implementation of the method 150 involves dispersing several self-networking nodes in a region exhibiting a fire or susceptible to a fire, the self-networking nodes being coupled to one or more sensors; and employing the one or more sensors to provide sensed data based on one or more environmental conditions.

In accordance with the method, the controller, such as the sensor-network controller 16 of FIG. 1 and/or the local controller 90 of FIG. 2, implements a first mechanism for associating the position information with sensed environmental conditions output from one or more sensors associated with the position information. The controller further implements a second mechanism for selectively prioritizing sensed environmental conditions. The second mechanism includes a power-control switch, such as the switch 88 of FIG. 2, that is adapted to selectively adjust power to sensors in accordance with priority values associated with sensed environmental conditions output via the sensors.

Another alternative implementation of the method 150 involves dispersing plural self-networking nodes in proximity to a fire or in a region where future fire-detection and/or measurement is desired, the plural self-networking nodes being coupled to one or more sensors; forming a network via the self-networking nodes; and then extracting data from the self-networking nodes, and providing extracted data to a database in response thereto.

While the present embodiments are discussed with reference to obtaining measurements pertaining to environmental conditions, embodiments of the present invention are not limited thereto. For example, many types of environments are susceptible to events that may affect environmental-sensor output and that would benefit from a sensor network and accompanying sensed-data collection method implemented according to an embodiment of the present invention. The terms “sensor” and “node” can be used interchangeably. A node is generally is intended to include one or more sensing devices along with control and other circuitry. However, the term “sensor” should also be construed to include one or more sensors and optional additional control or other circuitry as described herein for either sensors or nodes. Similarly, descriptions or discussion or use of either of the terms “node” or “sensor” is intended to imply the use of the other term unless otherwise stated.

Sensors and nodes do not need to have any specific ability to sense more than one number or certain type of environmental condition. For example, some nodes may report a condition without also providing location data. Some types of nodes, such as the relay nodes, are not required to sense any environmental condition at all.

Although a process or module of the present invention may be presented as a single entity, such as software executing on a single machine, such software and/or modules can readily be executed on multiple machines. Furthermore, multiple different modules and/or programs of embodiments of the present invention may be implemented on one or more machines without departing from the scope thereof.

Any suitable programming language can be used to implement the routines or other instructions employed by various network entities. Exemplary programming languages include nesC, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed simultaneously.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “machine-readable medium” or “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic; optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”, “an”, and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A system for monitoring a fire, the system comprising:
a plurality of devices coupled via a network, each with a plurality of sensors;
a base station for communicating with the devices;
a processing system for receiving data from the sensors via the base station; and
a process executing on one or more of the devices for organizing a flow of data from the devices to the base station after deployment of the devices.

2. The system of claim 1 further including:
first means for pre-deploying the devices in an area.

3. The system of claim 1 wherein the first means further includes:
second means for deploying the devices during a fire event.

4. The system of claim 1 further including:
third means for facilitating modifying data collection priorities.

5. The system of claim 4, wherein the third means further includes:
fourth means for facilitating modifying data collection priorities according to a data type, a data collection rate, and/or according to fire conditions.

6. A system for monitoring a plurality of mobile objects, the system comprising:
a plurality of devices coupled to the mobile objects, wherein each device includes a plurality of sensors, wherein the sensors include environmental sensors;
a base station for communicating with the devices;
a processing system for receiving data from the sensors via the base station; and
a process executing on one or more of the devices for organizing a flow of data from the devices to the base station after deployment of the devices.

7. The system of claim 6, wherein a mobile object includes a person or vehicle.

8. The system of claim 7, wherein the plurality of sensors include one or more sensors for measuring biological information of the user.

9. The system of claim 6 wherein the base station is mobile.

10. The system of claim 6 further including
first means for modifying data collection priorities according to data type, data collection rate, and/or values of data collected.

11. A method for obtaining measurements of environmental conditions comprising:
dispersing several self-networking nodes in a region, the self-networking nodes being coupled to one or more sensors; and
employing the one or more sensors to sense one or more environmental conditions, thereby yielding sensed data.

12. The method of claim 11, wherein the region includes a fire.

13. The method of claim 12, further including:
utilizing the sensed data to predict a condition pertaining to a fire.

14. The method of claim 13, wherein the condition pertaining to a fire includes:
fire movement.

15. The method of claim 13, wherein the condition pertaining to a fire includes:
fire temperature.

16. The method of claim 11, further including:
selectively controlling power to one or more of the one or more sensors based on a predetermined priority associated with sensed data output from the one or more sensors.

17. A method for obtaining fire measurements comprising:
creating a sensor network of spatially dispersed self-networking sensors, the sensor network being in proximity to or in the fire and
selectively controlling the sensor network to configure data received by a processing system from one or more sensors of the spatially dispersed sensor network.

18. The method of claim 17, further including:
dispersing plural self-networking nodes in proximity to the fire, each self-networking node in communication with one or more sensors.

19. The method of claim 17, wherein the data includes:
position information corresponding to one or more sensors of the sensor network.

20. The method of claim 19, wherein the position information includes:
elevation information.

21. The method of claim 19, further including:
implementing one or more routines for coupling the position information with sensed data corresponding to one or more environmental conditions.

22. The method of claim 21, further including:
employing the sensed data and the position information to predict behavior of the fire.

23. The method of claim 17, further including:
selectively prioritizing the data.

24. The method of claim 23, further including:
prioritizing the data based on bandwidth and/or communication capabilities of the sensors providing the sensed data.

25. The method of claim 23, further including:
selectively adjusting power to each of the spatially dispersed sensors according to a priority associated with priority value associated with each of the spatially dispersed sensors.

26. The method of claim 25, further comprising:
a GPS receiver, a humidity sensor, a temperature sensor, and/or a radiation sensor.

27. A system for facilitating fire measurement comprising:
sensors interconnected via a network, the sensors being adapted to sense environmental conditions;
one or more Global Positioning System (GPS) receivers adapted to provide position information associated with one or more of the sensors; and
a sensor controller connected to the network, the sensor controller adapted to selectively retrieve the sensed environmental conditions and the position information.

28. The system of claim 27, further comprising:
first means for associating the position information with sensed environmental conditions output from one or more sensors associated with the position information.

29. The system of claim 27, further comprising:
second means for selectively prioritizing sensed environmental conditions in response to control signals output from the sensor controller.

30. The system of claim 29, further comprising:
a power-control mechanism adapted to selectively adjust power to sensors in accordance with priority values associated with sensed environmental conditions output via the sensors.

31. The system of claim 29, wherein the sensors are connected to network nodes, further comprising:
a sensor-node controller and an accompanying GPS receiver.

32. The system of claim 31, further comprising:
means for selectively powering off the GPS receiver.

33. The system of claim 31, further comprising:
one or more routines to facilitate automatically wirelessly networking with proximate sensors and associated nodes.

34. The system of claim 31, wherein the sensor-node controller is responsive to control signals from the sensor controller.

35. The system of claim 34, wherein the sensor controller is implemented via a base station.

36. The system of claim 29, further comprising:
a user interface in communication with the controller.

37. The system of claim 36, wherein the user interface includes:
a browser-client interface.

38. The system of claim 36, further including:
a database in communication with the user interface.

39. The system of claim 38, further including:
one or more servers in communication with the sensor node controller and the database, the one or more servers adapted to selectively provide fire information to the browser-client interface based on the sensed environmental conditions.

40. The system of claim 27, wherein the position information includes:
elevation information.

41. A method for characterizing a wildfire comprising:
dispersing several nodes in a region exhibiting a fire or susceptible to a fire, the nodes being coupled to one or more sensors and being coupled to one or more Global Positioning System (GPS) receivers;
employing the one or more sensors to sense one or more environmental conditions and providing sensed data in response thereto;
coupling position and elevation information provided by the GPS receiver to the one or more environmental conditions and providing geocoded data in response thereto; and
characterizing the fire based on the geocoded data.

42. A method for characterizing a wildfire comprising:
dispersing plural self-networking nodes in proximity to a fire or in a region where future fire-detection and/or measurement is desired, the plural self-networking nodes being coupled to one or more sensors;
forming a network via the self-networking nodes; and
extracting data from the self-networking nodes and providing extracted data to a database in response thereto.

43. The method of claim 42, wherein dispersing includes aerial dispersal.

44. The method of claim 42, further including:
running one or more routines for predicting fire spread based on sensed data from the self-networking nodes.

45. The method of claim 42, further including:
one or more routines for correlating building structural with a fire behavior and/or characteristics based on sensed data associated with a structure and sensed data associated with the fire.

46. A system for monitoring a fire, the system comprising:
a plurality of devices, each with a plurality of sensors, wherein a priority is assigned to two or more sensors;
a base station for communicating with the devices; and
a processing system for receiving data from the sensors via the base station, wherein the data is received from the sensors according to the priority.

47. The system of claim 46, further comprising:
a process executing at a device for preventing operation of a sensor depending on a criterion.

48. The system of claim 47, wherein the criterion includes a determination of a low-power condition.

49. The system of claim 47, wherein the criterion includes a determination of a restricted bandwidth condition.
